(19) United States
(12) Patent Application Publication
(10) Pub. No.: US 2010/0283752 A1
(43) Pub. Date: Nov. 11, 2010

(54) CAPACITIVE TOUCH PANEL AND METHOD FOR DETECTING TOUCHED INPUT POSITION ON THE SAME

(75) Inventor: Takami MAEDA, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/769,155

(22) Filed: Apr. 28, 2010

(30) Foreign Application Priority Data
May 7, 2009 (JP) 2009-112450

(51) Int. Cl. G06F 3/041

(52) U.S. Cl. 345/173

(57) ABSTRACT

A capacitive touch panel of the present invention is characterized by including a plurality of detection period setting section 18 to 20 and electrode range setting section 21. Detection is performed by setting a detection period for electrodes 3 and 4, which are situated in a range previously determined with reference to the electrodes 3 and 4 where a touch input is detected, so as to become larger than a detection period achieved before detection of the touch input.

### BACKGROUND

1. Field of the Invention

The present invention relates to a capacitive touch panel that detects an operation input by means of a change in electrostatic capacitance, as well as to a method for detecting a touched input position on the touch panel.

2. Description of the Related Art

A recently-provided electronic white board system has a display unit for displaying an image, a coordinate input device (a touch panel device) whose coordinate input surface (a touch panel surface) is placed on a front surface of the display unit, and a controller that controls a display of the display unit in response to an input from the coordinate input device. A display surface and a coordinate input surface of an electronic white board section are built from the display unit and the coordinate input device.

A technique for imparting a special function to a coordinate input surface (a touch surface) of the coordinate input device provided on the display surface of the display unit, or the like, and detecting a characteristic change resultant from a touch on the coordinate input surface; namely, a so-called touch panel technique, has frequently been used as a coordinate detection technique for the coordinate input device employed in the electronic white board system, such as that mentioned above. For instance, a capacitive touch panel, an ultrasonic surface wave acoustic touch panel, and the like, have hitherto been known.

A pointing device combined with a touch panel has hitherto been put forward as an example capacitive touch panel of these touch panels (Patent Document 1). A transparent digitizer that makes it possible to make an internal display screen visible is laid on the display surface, thereby enabling intuitive identifying operation. Further, in order to pursuit an operator's intuitive sense, it is possible to perform input operation by directly touching the screen with a finger.

In such a capacitive touch panel, a plurality of electrodes laid in parallel along directions X and Y are connected to an oscillator circuit by way of an electrode selection circuit. Presence or absence of an input is detected by converting capacitive changes in the respective electrodes resultant from a touch on the coordinate input surface into frequency changes. The principle of the capacitive touch panel is described in; for instance, (Patent Document 2).

(Patent Document 3) and (Patent Document 4) describe a method for determining positional coordinates with superior accuracy by means of performing arithmetic processing in accordance with detection signals from the plurality of electrodes laid parallel to both the directions X and Y.
Patent Document 1: JP-A-08-179871
Patent Document 2: JP-B-04-048244
Patent Document 3: JP-B-04-034778
Patent Document 4: JP-A-07-129321

Many of the related-art capacitive touch panels predominantly measure 15 inches or less and yield an advantage of enabling entry of coordinates by means of a touch on a coordinate input surface with a finger or a pen (hereinafter referred to as a “touch input”). However, when electrodes are laid in a high-density array in order to enhance positional accuracy for detecting an input, the influence of static capacitance incidental to wiring of the electrodes, and the like, is also increased; therefore, growth in size of the touch panel has its limit.

For instance, in a capacitive touch panel measuring about 50 to 100 inches, static capacitance of one electrode comes to as much as tens of picofarads to hundreds of picofarads, including static capacitance incidental to wiring from the electrode to the control circuit.

By contrast, depending on the thickness or property of respective members making up a capacitive touch panel, changes in static capacitance resultant from a touch of a finger or a pen that are on the order of about 0.1 to 0.5 pF; namely, less than 1 pF, appear on an insulator cover intended for protecting the electrodes.

Accordingly, as the size of the panel increases, a detection value obtained as a result of touch input of a finger, or the like, becomes smaller and more vulnerable to the influence of noise, or the like.

In order to determine coordinates of a touch-input position with high accuracy from detection values acquired from a plurality of electrodes located in the vicinity of the touch-input position, the detection values of magnitude appropriate to the plurality of electrodes must be acquired.

However, when the static capacitance incidental to wiring of electrodes, and the like, becomes extremely larger than amounts of changes in static capacitance resultant from a touch of a finger, or the like, there may arise a case where detection values acquired from a plurality of electrodes located in the vicinity of the touch-input position will not assume sufficiently large values.

For these reasons, even when coordinates of the touch-input position are determined by subjecting the thus-acquired detection values to predetermined interpolation, or the like, the positional accuracy of the coordinates will become poor, which will in turn raise a problem of extremely poor operability being achieved when a graphic or text is input by use of a finger or a pen.

The present invention aims at providing a touch panel that acquires from a plurality of electrodes located in the neighborhood of a touch-input position detection values which are large enough for use in computing positional coordinates, thereby enabling highly-accurate, stable detection of a position.

### SUMMARY

In order to solve the problem, the present invention provides a capacitive touch panel comprising: a detection surface; a first electrode that is provided on the detection surface and that includes a plurality of electrodes arranged in parallel; a second electrode that is provided on the detection surface and that includes a plurality of electrodes arranged in parallel along a direction crossing the first electrode; a touch input detection section that detects a touch input on the detection surface made by a predetermined coordinate pointer in accordance with a change in electrostatic capacitance between the first and second electrodes; a detection period setting section that sets a period for selecting the first or second electrode, thereby setting a substantial detection period; and a control section that controls the detection period set by the detection period setting section in accordance with a result of detection performed by the touch input detection section, wherein the control section sets the detection period for an electrode from which the touch input is detected, among the first and second electrodes, longer than the detection period set theretofore.

The term “substantial detection period” used herein means a period during which the first or second electrode is selected when detection operation is performed and is hereinbelow referred to simply as a “detection period.”

According to the present invention, an electrode situated in the vicinity of a position of a touch input is taken as a reference on the basis of coordinates where the touch input is detected. After detection of a touch input, a detection period for electrodes situated in a range previously set with reference to the reference electrode is set so as to become longer than a detection period achieved before detection of the touch input. Control is thereby performed so as to enhance detection sensitivity for the electrodes situated in the range previously set with reference to the electrode located in the vicinity of the position of the touch input after detection of the touch input.

Once the touch input has been detected, when the next touch input stemming from movement of a finger is made in the coordinate range of the position where electrodes situated in the range can be detected, sensitivity for the range is enhanced, to thus enable acquisition of detection values of magnitude large enough for determining coordinates of the position of the touch input. Hence, there is yielded an advantage of the ability to enable easy detection of a touch input.

In particular, when an arrangement pitch for electrodes (hereinafter referred to as an “electrode pitch”) is larger than a finger or a stylus pen to be brought into touch with the panel; for instance, when the electrode pitch is 6 mm or more, there is yielded an advantage of the ability to enhance sensitivity when a point between the electrodes is touched.

Detection operation is performed after the detection period for electrodes situated in a range except the previously-set given range is set so as to become shorter than the detection period set before detection of a touch input, thereby decreasing detection sensitivity for the electrodes situated in the range except the predetermined range after detection of the touch input.

Once a touch input has been detected, detection sensitivity for the electrodes in the range except the predetermined range is decreased. Therefore, there is yielded an advantage of the ability to make detection less susceptible to influence of guidance by a closed fist, extraneous noise, and the like.

For instance, when a person touches his/her finger on a touch panel with the aim of drawing a line or a drawing on the touch panel surface, a closed fist portion of the hand touching the panel, an arm, and a body also become close to the touch panel surface incidental to the touching action.

It cannot be said that there will be no potential of the hand, arm, and body being erroneously detected as a “touch input.” If they are erroneously detected, the line or drawing displayed by the display unit on the touch panel surface will differ from that intended by the drawing person.

In order to prevent occurrence of such a problem, there is decreased input detection sensitivity for electrodes other than the electrodes located close to coordinates where a touch is detected, whereby the chance of occurrence of erroneous detection, which would otherwise be caused by a closed fist, or the like, can be lessened. As mentioned above, detection sensitivity for the electrodes located in the vicinity of the position of the touch input is enhanced, whilst there is lowered detection sensitivity for electrodes except the electrodes located in the vicinity of the position of the touch input. Thus, it becomes possible to acquire detection values of magnitudes large enough for determining coordinates of a position while the influence of extraneous noise, or the like, is eliminated.

Accordingly, coordinates of the position of a touch input can be determined with high accuracy by calculating coordinates from detection values acquired from a plurality of electrodes as a result of performance of a touch input.

Since it is possible to maintain at a given number or more the number of times a touch input can be detected within a unit time, a locus of a coordinate point of an input position is smooth even when a text, a line, a drawing, and others, is input. The chance of occurrence of erroneous detection can be diminished without deterioration of user's operability. Therefore, the present invention is also useful for applications of character recognition, gesture recognition, handwriting recognition, and the like.

### BRIEF DESCRIPTION OF THE DRAWINGS

FIG. 1 is a descriptive view showing an electronic white board system that is an application of a capacitive touch panel of a first embodiment of the present invention;

FIG. 2 is a schematic block diagram of the capacitive touch panel of the first embodiment of the present invention;

FIG. 3 is a block diagram showing some of a plurality of electrodes, detection control sections, a coordinate calculation control section in the capacitive touch panel of the first embodiment of the present invention;

FIG. 4 is a block diagram of a detection circuit control section making up the capacitive touch panel of the first embodiment of the present invention;

FIGS. 5A to 5C are cross-sectional views showing the principle of detection of the detection circuit making up the capacitive touch panel of the first embodiment of the present invention and a touch on a detection panel;

FIG. 6 is a general timing chart for selecting electrodes in the capacitive touch panel;

FIGS. 7A and 7B are charts of oscillation waveforms of a general detection circuit in the capacitive touch panel;

FIG. 8 is a timing chart for selecting electrodes after a touch input is detected by the detection control section making up the capacitive touch panel of the first embodiment of the present invention;

FIGS. 9A and 9B are charts of oscillation waveforms of the detection circuit making up the capacitive touch panel of the first embodiment of the present invention;

FIGS. 10A to 10D are views showing touch input to the capacitive touch panel of the first embodiment of the present invention;

FIG. 11 is a view showing distribution of detection values of respective electrodes making up the capacitive touch panel of the first embodiment of the present invention;

FIGS. 12A to 12D are views showing touch input to the capacitive touch panel of the first embodiment of the present invention;

FIG. 13 is a diagram showing a case where changes are made to a predetermined range according to the direction and speed of movements of a detected position of a touch input to the capacitive touch panel of the first embodiment of the present invention;

FIGS. 14A and 14B are views showing a first touch input to the capacitive touch panel of the first embodiment of the present invention and a detection value responsive to the entry;

FIGS. 15A and 15B are views showing a detection value responsive to an input to electrodes in a predetermined range achieved after detection of a touch input to the capacitive touch panel of the first embodiment of the present invention;

FIG. 16 is a flowchart for describing processing of a coordinate calculation control section making up the capacitive touch panel of the first embodiment of the present invention; and

FIGS. 17A and 17B are views showing an example reference table employed in the capacitive touch panel of the first embodiment of the present invention.

### DETAILED DESCRIPTION

An embodiment for implementing the present invention is hereunder described by reference to the drawings. The present invention is not limited to the embodiment.

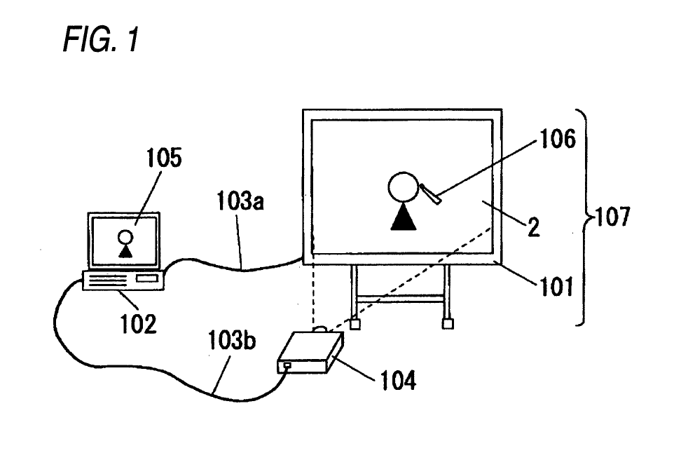

FIG. 1 is a descriptive view showing an electronic white board system that is an application of a capacitive touch panel of a first embodiment of the present invention. The electronic white board system shown in FIG. 1 is made up of a liquid crystal projector 104 and a detection panel 2 that work as a display unit; a coordinate input device 101; a computer 102 connected to them by way of communications cables 103a and 103b; and an electronic pen 106 used for making a handwritten input to the coordinate input device 101.

A display surface and a coordinate input surface (a write surface) of the electronic white board 107 are made up of the detection panel 2 and the coordinate input device 101. Display data reserved in the computer 102, such as texts, pictures, figures, and graphics, are delivered to the liquid crystal projector 104 connected to the computer by way of the communications cable 103b, and the thus-delivered display data are projected as an image, such as texts, pictures, figures, and graphics, on the detection panel 2.

It is possible to make a handwritten input to the coordinate input device 101 put on the front of a projection plane of the detection panel 2 by use of the electronic pen 106. The thus-input handwritten data are captured by the computer 102 by way of the communications cable 103a and combined with the previously described display data, such as texts, pictures, figures, and graphics, within the computer 102. Combined display data 105 are again projected as an image on the detection panel 2 by way of the liquid crystal projector 104.

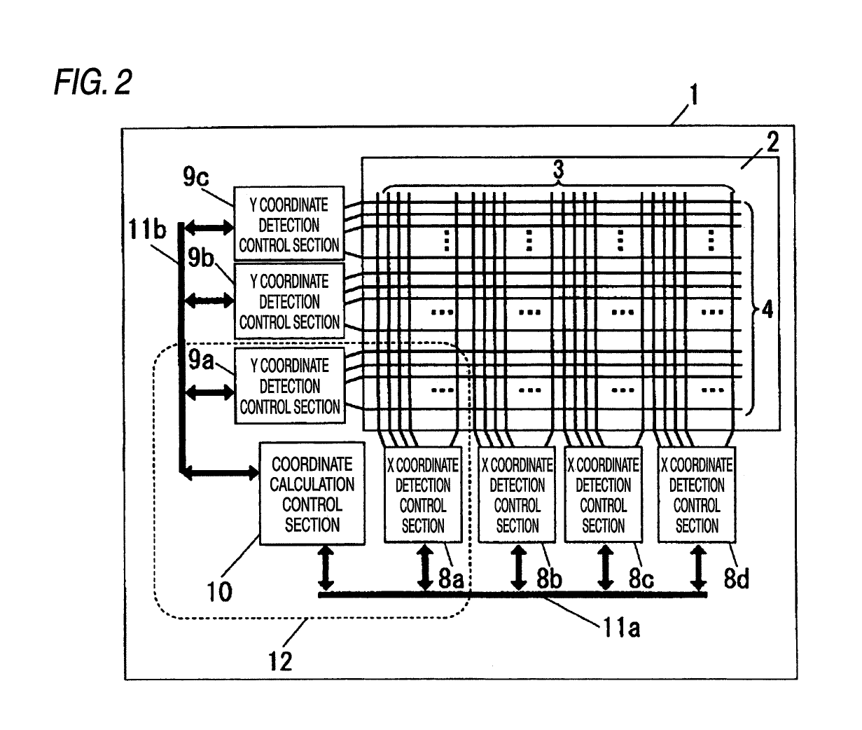

FIG. 2 is a schematic block diagram of the capacitive touch panel of the first embodiment of the present invention. In FIG. 2, reference numeral 2 designates a detection panel; 3 designates a plurality of column electrodes (hereinafter called “X electrodes”) making up the detection panel 2; 4 designates a plurality of row electrodes (hereinafter called “Y electrodes”) making up the detection panel 2; 8a to 8d designate an X coordinate detection control section that controls operation for detecting a touch input to any of the X electrodes; and 9a to 9c designate a Y coordinate detection control section that controls operation for detecting a touch input to any of the Y electrodes 4.

The X electrodes 3 are laid at given pitches parallel to each other, and the Y electrodes 4 are laid at given pitches parallel to each other along a direction perpendicular to the X electrodes 3.

In order to minimize electrostatic capacitance resultant from wiring of the X electrodes 3 and the Y electrodes 4, the X coordinate detection control sections are divided into four blocks 8a to 8d along an X-axis direction, and the Y coordinate detection control sections are divided into three blocks 9a to 9c along a Y-axis direction. These blocks are connected respectively to the coordinate calculation control section 10 by means of a communications bus 11a and a communications bus 11b.

In the blocks 8a to 8d and 9a to 9c, the respective detection control sections sequentially select respective electrodes in such a way that the sum of periods for selecting an electrode in the blocks (i.e., one scan period) falls within a given time, thereby performing detection operation.

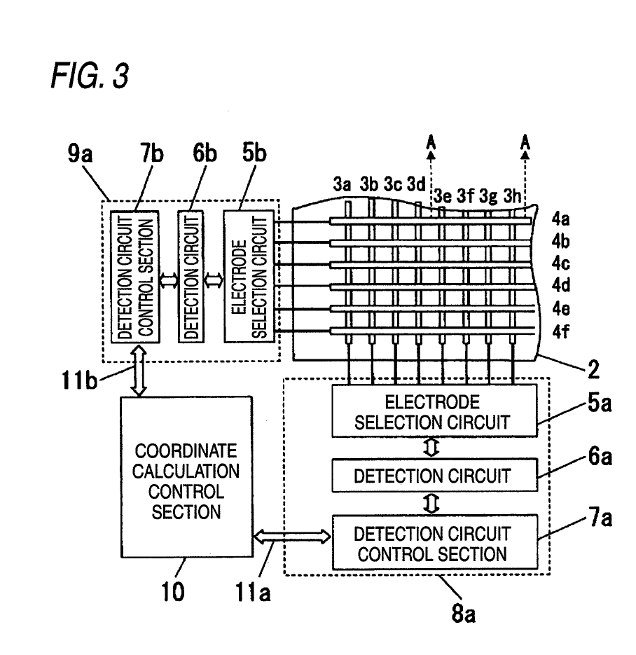

FIG. 3 is a block diagram showing some of a plurality of electrodes, detection control sections, a coordinate calculation control section in the capacitive touch panel of the first embodiment of the present invention. Namely, FIG. 3 is a block diagram (corresponding to; i.e., an area surrounded by a dotted line 12 in FIG. 2) showing some of the plurality of electrodes, the detection control sections 8a and 9a, and the coordinate calculation control section 10 in the capacitive touch panel 1 in FIG. 2.

In FIG. 3, reference numerals 3a to 3h designate X electrodes making up the detection panel 2; 4a to 4f designate Y electrodes also making up the same detection panel 2; 5a designates an X electrode selection circuit; 5b designates a Y electrode selection circuit; 6a and 6b designate detection circuits; and 7a and 7b designate detection circuit control sections.

In FIG. 3, the electrode selection circuit 5a for selecting any one from the plurality of X electrodes is connected to one end of each of the plurality of X electrodes 3a to 3h. The electrode selection circuit 5b for selecting any one from the plurality of Y electrodes is connected to one end of each of the plurality of Y electrodes 4a to 4f.

The detection circuit 6a has an oscillation circuit that causes oscillation at a cycle commensurate with electrostatic capacitance whereby an electrode selected by the electrode selection circuit 5a is coupled. The detection circuit 6a outputs a pulse signal appropriate to the oscillation cycle.

Likewise, the detection circuit 6b has an oscillation circuit that causes oscillation at a cycle commensurate with electrostatic capacitance whereby an electrode selected by the electrode selection circuit 5b is coupled. The detection circuit 6b outputs a pulse signal appropriate to the oscillation cycle.

The detection circuit control section 7a calculates the cycle of the pulse signal output from the detection circuit 6a for a case where the detection panel 2 is not touched by way of any of the X electrodes 3a to 3h and where the detection panel 2 is touched by way of any of them. When the detection panel 2 is touched, a change in electrostatic capacitance of the electrode resultant from the touch is transmitted, as a detection value determined from a cycle difference of the pulse signal, to the coordinate calculation control section 10 by way of the communications bus 11a.

Likewise, the detection circuit control section 7b calculates the cycle of the pulse signal output from the detection circuit 6b for a case where the detection panel 2 is not touched by way of any of the Y electrodes 4a to 4f and where the detection panel 2 is touched by way of any of them. When the detection panel 2 is touched, a change in electrostatic capacitance of the electrode resultant from the touch is transmitted, as a detection value determined from a cycle difference of the pulse signal, to the coordinate calculation control section 10 by way of the communications bus 11b.

The coordinate calculation control section 10 determines presence or absence of a touch input in accordance with the detection values transmitted from the detection circuit control sections 7a and 7b and a predetermined threshold value, and calculates coordinates where the touch input is detected. The thus-calculated coordinate information is transmitted to a computer (not shown) by way of a host I/F (not shown).

The relationship between the electrodes and detection control section of the capacitive touch panel 1 and the coordinate calculation control section 10 has thus been described in connection with only the area enclosed by the dotted line 12 shown in FIG. 2. However, as in the case with FIG. 3, the same also applies to the relationship between the other detection control sections 8b to 8d and 9b to 9d and un-illustrated electrodes connected thereto and the coordinate calculation control section 10.

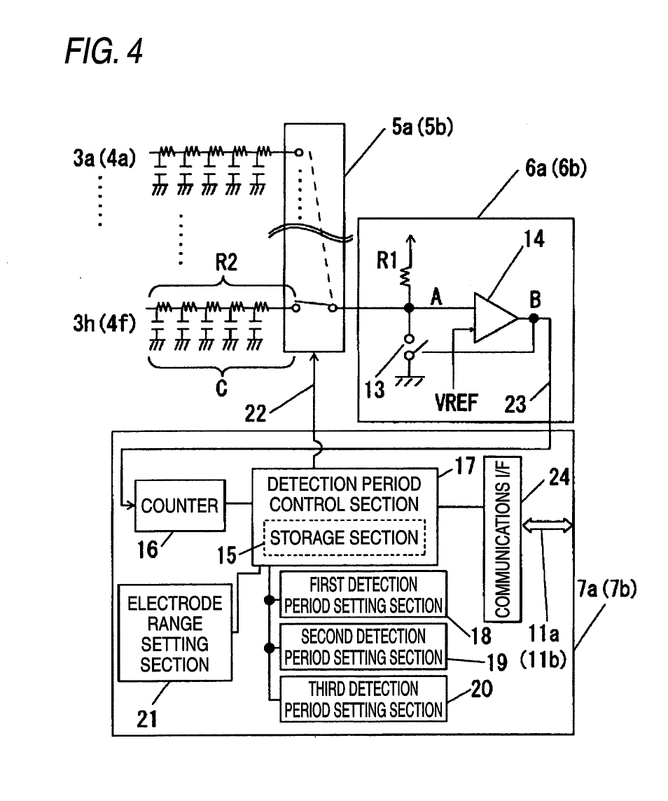

Operation of the detection circuit control section 7a performed after a touch input has been detected is now described by reference to FIGS. 3 and 4.

FIG. 4 is a block diagram of a detection circuit control section making up the capacitive touch panel of the first embodiment of the present invention; namely, a block diagram of the X coordinate detection control section 8a shown in FIG. 3. The Y coordinate detection control section 9a is also configured in the same manner as is the X coordinate detection control section 8a.

In FIG. 3, with reference to an electrode located in the vicinity of coordinates where a touch input is first detected, the coordinate calculation control section 10 identifies an X electrode and a Y electrode situated within a previously determined range from the electrode. Results (electrode identification information) is transmitted to the detection circuit control sections 7a and 7b by way of the communications buses 11a and 11b, respectively.

Specifically, the coordinate calculation control section 10 also has, as a feature of reference electrode identifying section, a function of identifying an electrode that is to serve as a reference on the occasion of determination of a range, in accordance with a plurality of detection values acquired through touch input detection.

In FIG. 4, the detection period control section 17 receives the X electrode identification information transmitted from the coordinate calculation control section 10 by way of a communications I/F section 24 and sets the thus-received information in an electrode range setting section 21 provided in the detection circuit control section 7a.

The detection circuit control section 7a has a plurality of detection period setting section 18, 19, and 20 that set detection periods for the X electrodes. Once a touch input has been detected, a plurality of detection periods differing from those set before detection of the touch input are set, thereby controlling detection of inputs in the X electrodes 3a to 3h.

Before detecting a touch input, the detection period control section 17 herein outputs a control signal 22 to the electrode selection circuit 5a in accordance with a detection period set by the first detection period setting section 18.

Meanwhile, once a touch input has been detected, the detection period control section 17 outputs the control signal 22 to the time electrode selection circuit 5a in accordance with the electrode identification information set by the electrode range setting section 21 and detection periods set by the second detection period setting section 19 and the third detection period setting section 20.

Specifically, in accordance with the electrode identification information set by the electrode range setting section 21, an electrode nearest to the position of the touch input (the term “nearest” is used in the sense of “located at the closest position”) is taken as a reference. Electrodes located in a predetermined range from the nearest electrode are subjected to detection during the detection period set by the second detection period setting section 19. Further, electrodes located outside the predetermined range are subjected to detection for the detection period set by the third detection period setting section 20.

The detection circuit 6a forms an oscillation circuit from the electrode selected by the electrode selection circuit 5a in accordance with the control signal 22. A change in electrostatic capacitance of the selected electrode resultant from the touch input is converted into a frequency, and the counter 16 provided in the detection circuit control section 7a measures a difference in time of an oscillation cycle from a pulse signal 23.

In relation to a detection period for electrodes located within the predetermined range determined with reference to the electrode nearest to the position of the touch input, a value that is larger than the value set in the first detection period setting section 18 is set in the second detection period setting section 19. Hence, when the detection panel 2 is touched, the value measured by the counter 16 increases correspondingly, so that a change in electrostatic capacitance caused by a touch becomes easy to detect. This section that there has been enhanced sensitivity to detect a change in the electrodes located within the predetermined range determined with reference to the electrode nearest to the position of the touch input.

The detection period control section 17 transmits time difference data pertaining to the oscillation cycle measured by the counter 16 to the coordinate calculation control section 10 by way of the communications I/F section 24 and the communications bus 11a.

Once the touch input has been detected as mentioned above, detecting operation of the detection circuit control section 7a is performed.

Turning back to FIG. 3, even in relation to the detection circuit control section 7b, the Y electrode identification information transmitted from the coordinate calculation control section 10 in the same manner as mentioned above is set in electrode range setting section (not shown) provided in the detection circuit control section 7b.

Further, the detection circuit control section 7b has a plurality of setting section (not shown) that set detection periods for Y electrodes. Once a touch input has been detected, a plurality of detection periods differing from those set before detection of a touch input are set, whereby the Y electrodes 4a to 4f are subjected to input detection.

In subsequent operations, a detection period control section (not shown) in the detection circuit control section 7b also performs the same operation as that of the detection period control section 17 mentioned above.

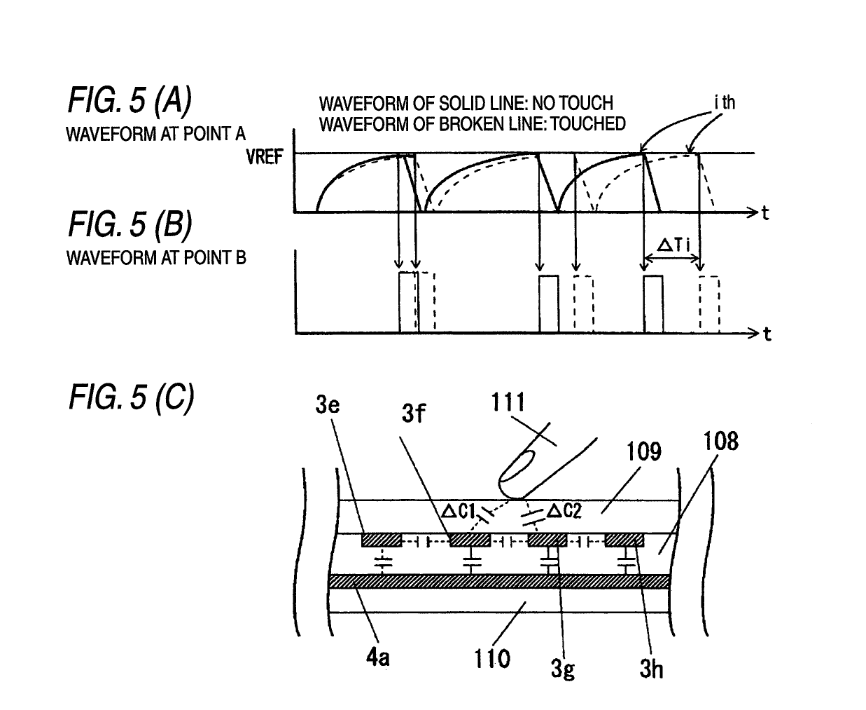

Operation of the detection circuit 6a is now described in detail by reference to FIG. 4 and FIGS. 5A to 5C.

As mentioned previously, FIG. 4 is a block diagram of a detection circuit control section making up the capacitive touch panel of the first embodiment of the present invention; namely, a block diagram of the X coordinate detection control section 8a. FIGS. 5A to 5C are cross-sectional views showing the principle of detection of the detection circuit making up the capacitive touch panel of the first embodiment of the present invention and a touch on a detection panel. FIG. 5A shows an oscillation waveform acquired in the detection circuit 6a. FIG. 5B shows a detection signal output from the detection circuit 6a. FIG. 5C shows a touch made to the detection panel 2.

In FIG. 4, the detection circuit 6a is made up of a time constant circuit, a voltage comparator 14, and a charge and discharge switch 13. The time constant circuit is made up of adjacent-interelectrode capacitance of electrodes, electrostatic capacitance C including both capacitance and stray capacitance resulting from intersection of the X electrode and the Y electrode, a resistance value R1 which determines a time constant, and an electrode resistance value R2 including wiring resistance. The switch 13 is controlled by the voltage comparator 14. When the voltage appearing at point B is H, the switch 13 is brought into an ON position. When the voltage is L, the switch 13 is brought into an OFF position.

The principle of operation of the thus-built detection circuit 6a is now provided. When the X electrode selection circuit 5a selects the X electrode provided with the touch input, the electrostatic capacitance C is charged by way of the resistance R1, whereupon the voltage appearing at the point A increases. When the voltage achieved at the point A reaches a VREF, a voltage appearing at point B, which is an output of the voltage comparator 14, becomes high, thereby turning on the switch 13. Electric charge in a capacitor of the selected electrode is discharged immediately, so that the voltage appearing at the point A falls to the VREF and below. Since the output of the voltage comparator 14 returns to a low level, the switch 13 is turned off, whereupon the electrostatic capacitance C is again recharged. The detection circuit 6a thus repeats discharge and recharge of the electrostatic capacitance C, whereby an oscillating state is continually held as indicated by a solid line shown in FIG. 5A. Further, a waveform of an output B of the voltage comparator 14 turns into a pulse waveform such as that indicated by a solid line in FIG. 5B.

FIG. 5C shows a state in which a coordinate pointer 111 (i.e., a finger shown in FIG. 5C) remains in contact with a cross-sectional plane A-A shown in FIG. 3. When the coordinate pointer 111 touches the detection panel 2, the X electrodes 3f and 3g located close to the touched point as shown in FIG. 5C are provided with electrostatic capacitance AC1 arising between the coordinate pointer 111 and an X electrode 3f and electrostatic capacitance AC2 arising between the coordinate pointer 111 and an X electrode 3g as well as the electrostatic capacitance C arising between the X electrodes 3f and 3g. As indicated by a broken line shown in FIG. 5A, the time elapsing before attainment of the VREF becomes longer as compared with the case where the coordinate pointer 111 does not touch the detection panel. Therefore, the oscillation cycle becomes longer. In this case, the waveform of an output B from the voltage comparator 14 turns into a pulse waveform, such as that indicated by a broken line shown in FIG. 5B.

Therefore, as shown in FIG. 5B, in relation to the case where the detection panel is touched and where the detection panel is not touched, it is determined whether or not a difference exists in the time elapsing before detection of the i^{th} pulse waveform from the first, whereby a touched electrode can be determined.

In FIG. 5C, reference numeral 108 designates a support element that supports, on its first surface, a first electrode (the X electrode) 3 working as a detection electrode and that supports, on the back side of the first surface (its second surface), a second electrode (the Y electrode) 4 working as a detection electrode while they are separated from each other. The support 108 is a flat sheet that has a thickness of; for instance, 70 μm to 250 μm and that is formed from a resin like PET. The detection electrode is patterned on both sides of the support 108. In this regard, the support 108 has a function of working as a flexible electrode substrate.

The first electrode (the X electrode) 3 and the second electrode (the Y electrode) 4 laid on both sides of the support 108 can be made by use of ink containing; for instance, silver particles, and by means of a so-called printing technique, an inkjet technique, a nozzle printing technique, and the like. A similar structure can also be acquired by subjecting the support 108 whose surfaces are coated with a metal film to etching, or the like.

Reference numeral 109 designates a protective layer (a front member) that is laid over the surface of the detection panel 2, to thus insulate the detection electrode (the first electrode 3) from the outside and protect the detection electrode from a physical contact of a finger or another. The protective layer (the front member) 109 is made of a phenolic resin having a thickness of 0.25 mm to 2 mm, or the like.

Reference numeral 110 designates a reinforcing material (a rear member) that prevents deformation of the detection panel 2 and a break in the detection electrode, which would otherwise be caused by a physical contact of the coordinate pointer 111. The reinforcing material (the rear member) 110 supports the support 108 from a side (its rear surface) opposite to the protective layer 109. The thickness of the overall reinforcing material (the rear member) 110 has no special limitations. An appropriate thickness can be selected according to the mode of use of a position sensor or the installation environment of the same.

The expression “reinforcing material” is again used even in embodiments to be described later as well as in the first embodiment. However, the present invention can find application regardless of whether or not an effect of reinforcing the support 108 so as not to be deformed is yielded.

The protective layer (the front member) 109, the support 108, and the reinforcing material (the rear member) 110 are bonded together by means of an adhesive, to thus be stacked in this sequence.

Operation of the detection circuit 6b is identical with that of the detection circuit 6a.

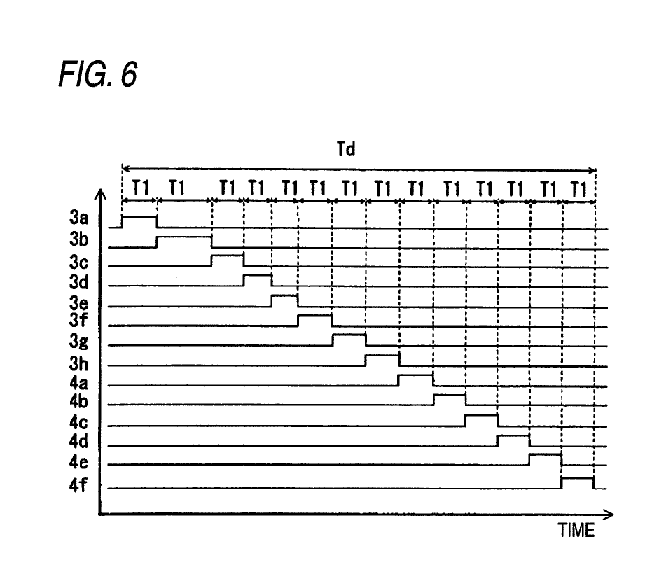

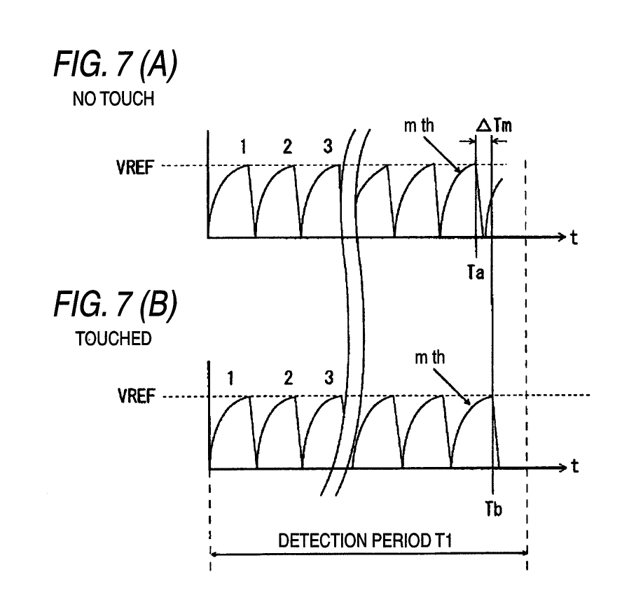

Next, operation of the detection circuit control section 7a is further described while being compared with operation of a common detection circuit. FIG. 6 is a general timing chart for selecting electrodes in the capacitive touch panel. FIGS. 7A and 7B are charts of oscillation waveforms of a general detection circuit in the capacitive touch panel.

In general, the X electrodes 3a to 3h and the Y electrodes 4a to 4f are sequentially selected (a selected state is achieved when each of the signals is at a high level) within a given period T1 as shown in FIG. 6, thereby detecting a change in electrostatic capacitance of each of the electrodes within the predetermined, given detection period T1. As shown in FIGS. 7A and 7B, it is determined, within the given detection period T1 of each of the electrodes, whether or not a difference ΔTm has occurred in the time elapsing before detection of the m^{th} (“m” is a natural number) oscillation waveform from the first, thereby determining a touched electrode.

In this case, so long as the value of the detection period T1 and the value of “m” are set to larger values, the time difference ΔTm can be made much greater. However, determining one position entails consumption of a much longer time, which in turn results in a decrease in the number of positions that can be detected within a unit time.

As a result, position detection processing cannot follow an operator's operation, which considerably deteriorates operability.

In order to avoid such a problem, T1 is usually set in such a way that a total sum of detection periods T1 of the respective X electrodes and the Y electrodes provided for one operation comes to a predetermined allowable time Td, thereby assuring operability.

The principal characteristic of the present invention is hereunder described on the basis of the configuration that has been provided thus far. Operation performed in the first embodiment of the present invention is first described predominantly by reference to FIGS. 4, 6, 8, and FIGS. 9A and 9B.

FIG. 6 is as previously described a timing chart showing detection periods of respective electrodes employed particularly when detection operation is performed. The drawing is used even in the first embodiment as a timing chart showing detection periods of respective electrodes employed when no touch input is detected.

Similarly, as previously described, FIG. 7 also shows, even in the first embodiment, oscillation waveforms of the respective electrodes appearing when the touch panel is not touched and when a touch input is first detected.

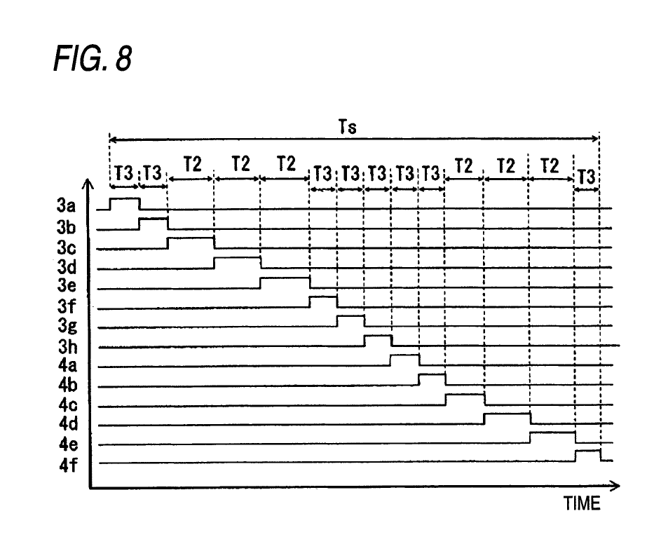

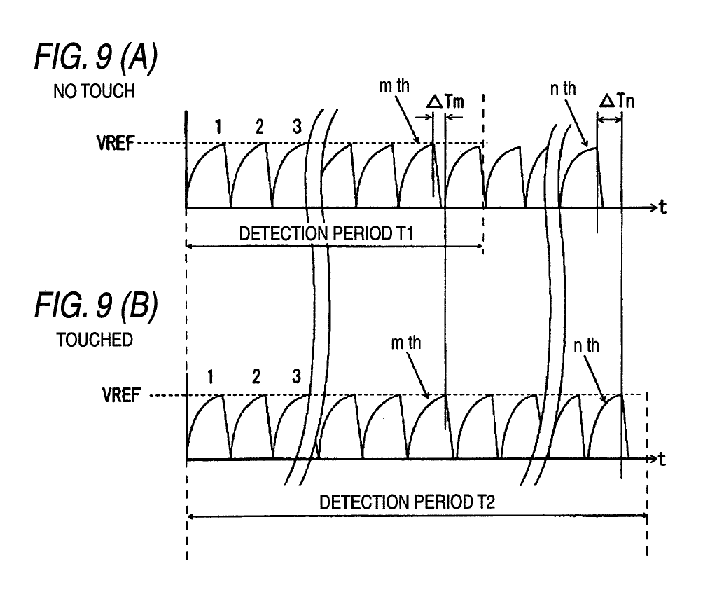

FIG. 8 is a timing chart for selecting electrodes after a touch input is detected by the detection control section making up the capacitive touch panel of the first embodiment of the present invention. FIGS. 9A and 9B are charts of oscillation waveforms of the detection circuit making up the capacitive touch panel of the first embodiment of the present invention.

As in the related-art common case, before first detection of a touch input, the electrode selection circuits 5a and 5b shown in FIG. 3 sequentially select the X electrodes 3a to 3h and the Y electrodes 4a to 4f at timings shown in FIG. 6, and the detection circuits 6a and 6b shown in FIG. 3 perform operation for detecting a touch input in the respective electrodes 3a to 3h and 4a to 4f shown in FIG. 6 within the predetermined, given detection periods T1.

Specifically, a value corresponding to T1 is set in the first detection period setting section 18 shown in FIG. 4 before first detection of a touch input in such a way that the detection periods of the respective electrodes assume the same time T1.

When the detection panel 2 is touched, the detection circuit 6a shown in FIG. 3 or 4 first detects a change in electrostatic capacitance of the X electrodes 3a to 3h shown in FIG. 3 resultant from the touch input in the form of a difference (ΔTm) in time elapsing before detection of the m^{th} oscillation waveform from the first, as shown in FIGS. 7A and 7B.

Specifically, when a touch input is not provided, the counter 16 shown in FIG. 4 first counts a time Ta elapsing before the m^{th} oscillation waveform from the first is detected in the electrode selected by the electrode selection circuit 5a, as shown in FIGS. 7A and 7B.

In the descriptions provided above, the time elapsing before detection of the m^{th} (“m” is a natural number) oscillation waveform from the first is counted within the period during which each of X electrodes is selected. However, the count value differs according to the size of a finger touched the panel. Therefore, The value of “m” is set in advance to an appropriate value such that the m^{th} oscillation waveform from the first appears within the detection period T1.

As previously described, the term “detection period” does not refer to a time elapsing before detection of the m^{th} (“m” is a natural number) oscillation waveform from the first but means a time for selecting respective electrodes.

The electrode selection circuit 5a shown in FIG. 4 sequentially selects the X electrodes 3a to 3h and the Y electrodes 4a to 4f at timings shown in FIG. 6 and temporarily stores respective count values acquired from the respective electrodes into a storage section (not shown) provided in the detection period control section.

In subsequent operation, the respective electrodes are sequentially selected at similar timings. The count values stored in the storage section are subtracted from corresponding count values acquired from the respective electrodes. Resultant values are taken as detection values, and data pertaining to the detection values are transmitted to the coordinate calculation control section 10.

Next, when the touch panel is touched, the touch induces a change in electrostatic capacitance of a certain electrode. The time elapsing before appearance of the m^{th} oscillation waveform from the first is assumed to have changed to Tb in the electrode as shown in FIG. 7B, a value corresponding to a time difference (ΔTm) determined by Tb−Ta is transmitted to the coordinate calculation control section 10 as a difference between sets of the count data pertaining to the electrode.

The coordinate calculation control section 10 shown in FIG. 3 determines whether or not a touch input is detected according to a determined as to whether or not received detection values acquired from the X electrodes 3a to 3h and the Y electrodes 4a to 4f surpass a first threshold value. When a touch input is determined to be successfully detected, coordinates of the position of the touch input are determined from detection data pertaining the plurality of electrodes used for determination.

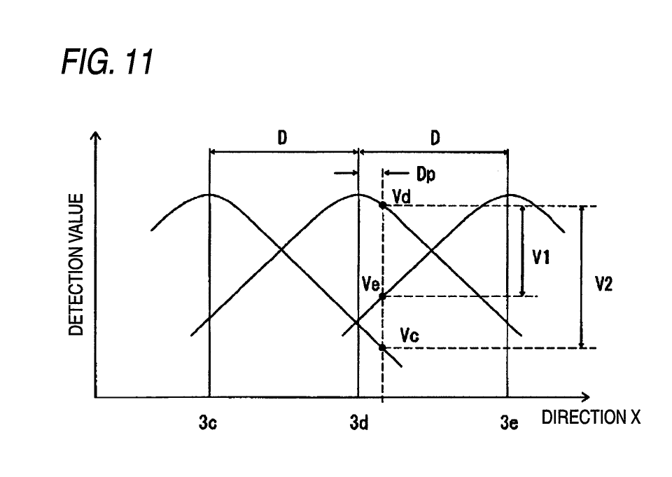

FIG. 11 is a view showing distribution of detection values of respective electrodes making up the capacitive touch panel of the first embodiment of the present invention. For instance, when a position spaced from the X electrode 3d shown in FIG. 11 by Dp is touched, detection values Vc, Vd, and Ve are detected in the respective X electrodes 3c, 3d, and 3e. Since the X electrodes are placed at equal pitches, an X coordinate of the position of the touch input can be determined as follows.

Specifically, detection values from the respective X electrodes are substantially proportional to a distance from the position of the touch input. Therefore, provided that a pitch at which the respective X electrodes 3c, 3d, and 3e are arranged is D; that a difference between Vd and Ve is V1; that a difference between Vd and Vc is V2; and that a distance from the X electrode 3d nearest to the position of the touch input to the position of the touch input is Dp, a relational expression is expressed by the following equation.

V1/V2=(D/2−Dp)/(D/2) (1).

The distance from the electrode Vd to the position of the touch input, which is taken as Dp, is given by the following expression.

Dp=(D/2)(1−V1/V2) (2).

Accordingly, an X coordinate of the position of the touch input can be calculated from the detection values Vc, Vd, Ve acquired respectively from the X electrodes 3c, 3d, 3e. A Y coordinate of the position of the touch input can also be determined by the same method.

The above descriptions show the case where coordinates of the position of the touch input are determined by calculating the position of a touch input from detection values of three electrodes; namely, by utilization of a kind of so-called three point interpolation. However, the present invention is not limited to the technique. The position of the touch input may also be determined from detection values acquired from a larger number of electrodes by use of another interpolation technique; for instance, a bilinear interpolation technique and a three-dimensional convolution interpolation technique.

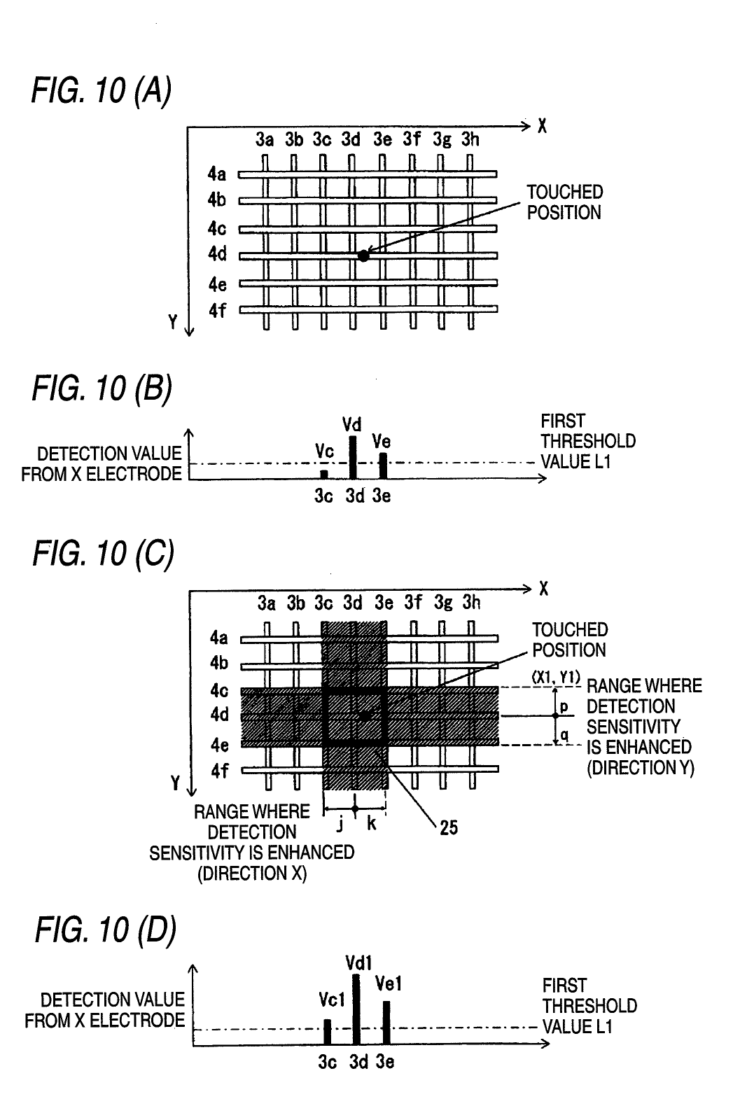

Operation of the detection control section 7a performed once the touch input has been detected is now described predominantly by reference to FIG. 8, FIGS. 9A and 9B, and FIGS. 10A to 10D.

FIGS. 10A to 10D are views showing touch input to the capacitive touch panel of the first embodiment of the present invention.

As previously described, FIG. 8 is a timing chart of respective electrodes acquired after a touch input is detected in a position between the X electrodes 3d and 3e and a position on the Y electrode 4d (a position indicated by arrow in FIG. 10A). The detection period control section 17 shown in FIG. 4 performs control so as to change, to T2 that is a value larger than T1, a detection period for electrodes in a predetermined range (electrodes in an obliquely-shaded range in FIG. 10C) determined in advance with reference to an electrode nearest to coordinates of the position where the touch input is detected, thereby performing detecting operation.

Moreover, the detection period control section 17 performs control so as to carry out detection operation by changing the detection period for the electrodes except the electrodes located in the range to T3 that is smaller in value than T1.

FIG. 9A shows an oscillation waveform appearing before detection of a touch input given to an electrode in the range; for instance, the electrode 3d. FIG. 9B shows an oscillation waveform appearing after detection of the touch input given to the electrode.

As shown in FIG. 9B, once the touch input has been detected, a change in electrostatic capacitance of the electrode resultant from the touch input is detected in the form of a difference (ΔTn) in time elapsing before appearance of the n^{th} oscillation waveform.

Reference symbol “n” denotes a natural number fulfilling a relationship n>m, and the natural number makes it possible to make ΔTn larger than ΔTm. Hence, there is yielded an advantage of the ability to enhance the sensitivity of detection of the electrodes in the range.

Meanwhile, the detection period for the electrodes other than the electrodes located in the range is given T3 that is smaller in value than T1, thereby yielding an advantage of reducing the sensitivity of detection of the electrodes except the electrodes located in the range.

Operation of the detection circuit control section 7a shown in FIG. 3 performed after detection of a touch input is now described in a more detail by reference to FIGS. 10A to 10D.

The respective electrodes are sequentially selected in the given time T1 until a touch input is first detected as mentioned previously.

First, when the detection period is T1, detection values acquired from the respective X electrodes 3c, 3d, 3e when the position indicated by arrow shown in FIG. 10A is touched are taken as Vc, Vd, Ve in the same manner as described previously. The case is shown in FIG. 10B.

The respective detection values acquired from the respective electrodes are substantially proportional to the distance from the position of the touch input. Therefore, so long as an electrode exhibiting the maximum detection value is determined from the plurality of detection values Vc, Vd, and Ve, the electrode (the X electrode 3d in this case) is determined to be an X electrode nearest to the position of the touch input.

However, when the detection period is T1, the detection value Vc acquired from the electrode 3c is less than a first threshold value L1 serving as a standard for determining input detection, as shown in FIG. 10B. Therefore, the detection value is not determined to be an effective detection value, and previously-mentioned Equation (2) requiring three detection values cannot be used.

Therefore, in order to calculate coordinates by use of Equation (2), detection sensitivity must be enhanced in such a way that the detection values acquired from at least three electrodes 3c, 3d, and 3e surpass the first threshold value L1.

Accordingly, a range is determined in advance with reference to the electrode exhibiting the maximum detection value, and the range is stored in a storage section (not shown) provided in the coordinate calculation control section 10. In this case, an arrangement pitch for electrodes is taken as one unit by utilization of an array in which the respective electrodes are arranged at a given pitch and parallel to each other. The range is determined from the number of units, whereby amounts of computation are curtailed.

An X electrode exhibiting a maximum detection value is taken as a reference, and a single arrangement pitch for the X electrodes in respective positive and negative directions along the X axis is taken as one unit. A range is determined by a predetermined number of units. The detection period control section 17 performs control so as to change a detection period for the X electrodes 3c, 3d, and 3e in the range to T2, thereby performing detecting operation.

Likewise, in relation to the Y electrodes, a Y electrode exhibiting a maximum detection value is taken as a reference, and a single arrangement pitch for the Y electrodes in respective positive and negative directions along the Y axis is taken as one unit. A range is determined by the predetermined number of units. The detection period control section 17 performs control so as to change a detection period for the Y electrodes 4c, 4d, and 4e in the range to T2, thereby performing detecting operation.

Detection can be performed, with enhanced detection sensitivity, in the electrodes for which the detection period is changed to T2 as mentioned above. Hence, the range of both the Y electrodes sand X electrodes where detection can be performed with enhanced detection sensitivity is changed to at least a range surrounded by a thick line 25 shown in FIG. 10C.

Detection values Vc1, Vd1, and Vel acquired respectively from the X electrodes 3c, 3d, and 3e for which the detection period is changed to T2 become greater than the detection values Vc, Vd, and Ve acquired when the detection period is T1 in terms of a value, as shown in FIG. 10D.

Therefore, the coordinate calculation control section 10 can calculate coordinates from the detection values acquired with enhanced sensitivity and by use of Equation (2), so that coordinates of the position can be determined with high accuracy.

The above descriptions mention that the range where detection can be performed with enhanced detection sensitivity corresponds to at least the area surrounded by the thick line 25 shown in FIG. 10C. However, the range of coordinates where detection can be performed with enhanced detection sensitivity extends, in reality, to both sides of the electrodes. Therefore, the range of coordinates where detection can be performed with enhanced sensitivity is larger than the area surrounded by the thick line 25 shown in FIG. 10C.

For instance, the range of coordinate lines in the area indicated by oblique lines shown in FIG. 10C and located between the X electrode 3e and the X electrode 3f, enhancement of detection sensitivity can be expected even outside the area surrounded by the bold line 25 shown in FIG. 10C.

Specifically, the predetermined range can be designated not only by a method for specifying a range through use of a unit determined from an arrangement pitch for electrodes. The predetermined range can also be designated as a range of coordinates. Accordingly, it is also possible to perform detecting operation by changing a detection period for electrodes that enable detection of coordinate points in a range previously determined from a positional relationship with coordinates of a position where a touch input has been detected.

Detection is performed in the electrodes except the electrodes located within the range indicated by the oblique lines shown in FIG. 10C by decreasing the detection sensitivity for the electrodes by means of changing the detection period to T3 that is smaller in value than T1. Hence, occurrence of erroneous detection in the electrodes, which would otherwise be caused by noise or the like, can be prevented.

As mentioned previously, when the position indicated by the arrow shown in FIG. 10A is touched, the detection control sections 8a and 9a shown in FIG. 3 transmit, to the coordinate calculation control section 10 shown in FIG. 3, detection values of the X electrode and the Y electrode where the touch input is detected.

Detailed explanations are now provided with regard to operation of the coordinate calculation control section 10 that will be performed when coordinates (X1, Y1) of the position of a touch input are calculated from a plurality of detection values transmitted from the detection control sections 8a and 9a shown in FIG. 3 by means of Equation (2).

The respective electrodes are arranged at equal pitches and parallel to each other as mentioned previously. Provided that an arrangement pitch for the X electrodes is Dx and for the Y electrodes is Dy, the coordinate calculation control section 10 shown in FIG. 3 determines the X electrode 3d exhibiting the maximum detection value from the plurality of detection values used for detecting the touch input.

Identification information is then transmitted from the coordinate calculation control section 10 to the detection period control section 17 by way of a communications UF 24. Specifically, the identification information pertains to the electrodes 3c, 3d, and 3e situated in the range Dx that is determined with reference to the X electrodes 3d in the positive and negative directions along the X axis. The detection period control section 17 sets the identification information in the electrode range setting section 21.

The detection period control section (not shown) in the detection circuit control section 7b also sets identification information in the electrode range setting section 21 in an analogous fashion. The information pertains to electrodes 4c, 4d, and 4e situated in the range Dy that is determined with reference to the Y electrode 4d in both the positive and negative directions along the Y axis.

The range is determined from the arrangement pitches for the X and Y electrodes, with reference to a reference electrode, and in the positive and negative directions of both the X and Y axes. The number of electrodes situated in the range is, hence, equivalent to the number of electrodes counted from the reference electrode in both positive and negative directions along the respective X and Y axes.

For instance, in relation to the direction of the X axis in FIG. 10C, the number of electrodes located in the range Dx with reference to the X electrode 3d and along the positive and negative directions (except the electrode serving as a reference) is one.

Accordingly, FIG. 10C shows a case where, on condition that X electrodes situated in a previously-determined range are counted from the X electrode 3d serving as a reference with respect to the X coordinate, thereby being represented by means of an electrode located at the j^{th} position in the negative direction along the X axis and the k^{th} position in the positive direction along the same, the range previously set with respect to the negative and positive directions of the X axis is defined as (j, k)=(1, 1).

Specifically, a range to be set in advance with reference to an X electrode nearest to coordinates of the position of a touch input is a range determined from the arrangement pitch for the X electrodes. The range is expressed by the previously-set number of counts from the reference in both the positive and negative directions along the X axis.

Meanwhile, FIG. 10C also shows a case where, on condition that Y electrodes situated in a previously-determined range are counted from the Y electrode 4d serving as a reference with respect to the Y coordinate, thereby being represented by means of an electrode located at the p^{th} position in the negative direction along the Y axis and the q^{th} position in the positive direction along the same, the range previously set with respect to the negative and positive directions of the Y axis is defined as (p, q)=(1, 1).

Namely, a range to be set in advance with reference to a Y electrode nearest to coordinates of the position of a touch input is a range determined from the arrangement pitch for the Y electrodes. The range is expressed by the previously-set number of counts from the reference in both the positive and negative directions along the Y axis.

In FIG. 3, the coordinate calculation control section 10 determines the X electrode 3d exhibiting the maximum detection values among the plurality of detection values with regard to the X electrode, as mentioned previously. Likewise, the section 10 also determines the Y electrode 4d with regard to the Y electrode. Identification information about X electrodes located in the range specified by (j, k) with reference to the X electrode 3d and Y electrodes located in the range specified by (p, q) with reference to the Y electrode 4d are set in the electrode range setting section 21.

The coordinate calculation control section 10 calculates the number of electrodes located before an X electrode situated in the range specified by (j, k), by means of counting the electrodes from the first electrode 3a on the X axis. A count value obtained as a calculation result is set in the electrode range setting section 21 as identification information about the X electrode.

The coordinate calculation control section 10 also calculates the number of electrodes located before a Y electrode situated in the range specified by (p, q), by means of counting the electrodes from the first electrode 4a on the Y axis. A count value obtained as a calculation result is set in the electrode range setting section 21 as identification information about the Y electrode.

The operations are described by reference to FIG. 10C. FIG. 10C shows a case where the range is specified by (j, k)=(1, 1) with reference to the X electrode 3d. Provided that the first electrode 3a on the X axis is taken as zero, the X electrodes 3c, 3d, and 3e falling within the range are counted from the electrode 3a as count values 2, 3, and 4.

Accordingly, the count values 2, 3, and 4 are set in the electrode range setting section 21 as identification information about the X electrodes.

FIG. 10C also shows a case where the range is specified by (p, q)=(1, 1) with reference to the Y electrode 4d. Provided that the first electrode 4a on the Y axis is taken as zero, the Y electrodes 4c, 4d, and 4e falling within the range are counted from the electrode 4a as count values 2, 3, and 4.

Consequently, the count values 2, 3, and 4 are set as identification information about the Y electrodes in the electrode range setting means (not shown) provided in the detection circuit control section 7b shown in FIG. 3.

As mentioned above, in order to determine identification information set in the electrode range setting means, a distance from a reference electrode nearest to the coordinate of the position of a touch input is determined from an arrangement pitch for electrodes with respect to the direction of arrangement of the electrodes. The distance is previously stored as a count value in the storage section (not shown) provided in the coordinate calculation control section 10.

An electrode situated within the range extending a count value from the reference electrode is sought. The number of electrodes located before the thus-sought electrode is counted from the first electrode in each of the axes. A resultant count value is used as identification information.

After a touch input has been detected, the electrode selection circuit 5a sequentially selects an X electrode from the electrode 3d. In this case, when a match exists between the thus-selected electrode and the electrode represented by the X electrode identification information set in the electrode range setting section 21, the control signal 22 is output to the electrode selection circuit 5a within the detection period T2 set in the second detection period setting section 19. When no match exists between the thus-selected electrode and the electrode represented by the X electrode identification information set in the electrode range setting section 21, the control signal 22 is output to the electrode selection circuit 5a within the detection period T3 set in the second detection period setting section 19.

The detection periods for the respective electrodes are determined at timings shown in FIG. 8 as mentioned above, and the detection period control section 17 controls the detection periods.

In this case, the coordinate calculation control section 10 shown in FIG. 3 calculates the detection period T2 for the X electrodes 3c, 3d, 3e and the Y electrodes 4c, 4d, 4e and the detection period T3 for the other electrodes in such a way that a total sum Ts of the detection periods for both the X electrodes and the Y electrodes falls within the allowable time Td. The values of the periods T2 and T3 are transmitted to the detection period control section 17 by way of the communications I/F 24. The detection period control section 17 sets the thus-received T2 in the second detection period setting section 19 and T3 in the third detection period setting section 20.

In the foregoing, provided that the number of electrodes in the range; namely, the number of electrodes for which the detection period is increased is taken as Nc and that the sum of the number of X electrodes and the number of Y electrodes is Nt, the coordinate calculation control section 10 shown in FIG. 3 determines T2 and T3 so as to fulfill relational expressions (3) and (4) provided below.

NcT2+(Nt−Nc)T3≦Td (3).

T2>T3 (4).

In Expression (3), a value of Nt and a value of Td are constant. The essential requirement is to set a value of T2 to a predetermined value in advance and further set a value of T3 fulfilling Expressions (3) and (4) according to the position of a touch input. As mentioned above, even when there is increased a detection period for electrodes situated in a range set in advance with reference to an electrode near the position of a touch input, the number of times a touch input is detected can be maintained at a given number or a greater value without involvement of a decrease in the number of times a touch input can be detected within a unit time.

Accordingly, even when traveling speed of a finger or a pen achieved during operation for drawing and inputting lines, graphics, and the like is fast, it is possible to reliably carry out detection within a determined period of time by following movement of the finger, or the like. Therefore, an advantage of the ability to provide a touch panel exhibiting superior ease of follow and superior operability is yielded.

Moreover, there is changed a detection period for electrodes situated in a range determined in advance with reference to an electrode located in the vicinity of the position of a touch input. It is thereby possible to enhance sensitivity to detect electrodes situated in the range on the basis of coordinates of the input acquired after detection of the touch input.

The sensitivity to detect electrodes except the electrodes situated within the range is simultaneously decreased. Detection values of magnitudes enough for detecting coordinates of the position of the touch input can be acquired while the sensitivity is made less vulnerable to the influence of guidance by a closed fist, extraneous noise, and the like. Therefore, stable, high-precision detection of a touch input becomes possible.

In particular, when touch input operation is performed with a finger, a finger tip of a child is smaller than that of an adult, and a contact area achieved by the child's finger measures about 5 to 7 mm in diameter while being presumed to be analogous to a circle. Accordingly, even when an input is made by a child's finger, the present invention enables acquisition of a detection value of sufficient magnitude. The chance of occurrence of a failure, such as successful detection of a touch input or unsuccessful detection of the same, which would otherwise be caused by the size of a coordinate pointer, can be diminished.

Accordingly, the capacitive touch panel is useful for a case where coordinates of the position of a touch input are determined with high accuracy by computing coordinates from detection values acquired from a plurality of electrodes as a result of the touch input.

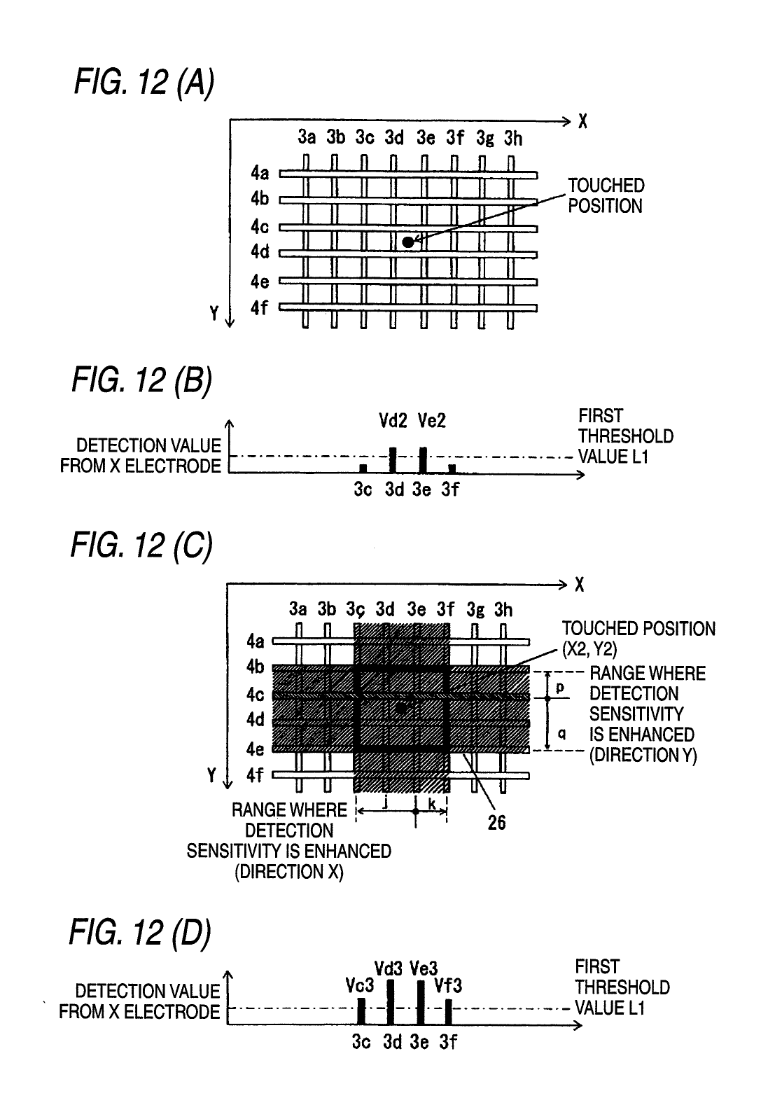

FIGS. 12A to 12D are views showing a touch input made on the capacitive touch panel of the first embodiment of the present invention.

FIG. 12A shows a case where a touched position corresponds to a midpoint between the electrodes 3d and 3e with respect to the X coordinate and a midpoint between the electrodes 4c and 4d with respect to the Y coordinate.

In such a case, when a detection value Vd2 acquired from the X electrode 3d and a detection value Vet acquired from the X electrode 3e are equal to each other as shown in FIG. 12B, any one of the electrodes; for instance, an electrode distal from a point of origin, is previously determined to be an electrode nearest the position of the touch input.

The electrode 3e is herein taken as a reference X electrode, and the electrode 4c is taken as a reference Y electrode. Electrodes situated within a previously-determined range are sought.

The previously-determined range corresponds to that indicated by oblique lines in FIG. 12C. In FIG. 12C, the X electrode 3e is taken as a reference and specified by (i, k)=(2, 1) in the same manner as described by reference to FIGS. 10A to 10D, and the Y electrode 4c is also taken as a reference and specified by (p, q)=(1, 2).

Specifically, with regard to the X coordinate, electrodes situated within a range sandwiched between the electrode 3c and the electrode 3f (including both the electrodes 3c and 3f) are objects of detection. Further, with regard to the Y coordinate, electrodes situated within a range sandwiched between the electrode 4b and the electrode 4e (including both the electrodes 4b and 4e) are objects of detection.

A range that enables detection of both the X electrodes and the Y electrodes with high detection sensitivity is at least a range enclosed by a thick line 26 shown in FIG. 12C.

As a result of detection being performed in the range with enhanced detection sensitivity, a detection value Vc3 acquired from the X electrode 3c and a detection value Vf3 acquired from the X electrode 3f also surpass the threshold value L1 as shown in FIG. 12D. Four detection values can be used for calculating coordinates. Consequently, use of an interpolation technique with higher accuracy, such as an interpolation technique utilizing four points, becomes feasible.

The first embodiment of the present invention has mentioned the case where the detection period for the X electrodes and the Y electrodes situated in the range previously determined from the coordinates where the touch input is detected are set to the same time T2. The detection period for the X electrodes and the detection period for the Y electrodes, however, may also be set to different times.

As a result of the detection periods being set as mentioned above, the sensitivity to detect the X electrodes in the previously-set range and the sensitivity to detect the Y electrodes in the same can be set independently. Therefore, there is yielded an advantage of the ability to correct a difference in sensitivity to detect the X electrodes and the Y electrodes ascribable to positions or configuration of the electrodes.

There is also provided the case where the detection period for X electrodes and the detection period for Y electrodes, except for the X electrodes and the Y electrodes situated in the range previously set with reference to the X electrodes and the Y electrodes determined from the plurality of detection values used for detecting the touch input, are set to the same time T3. The detection period for the X electrodes and the detection period for the Y electrodes, however, may also be set to different times.

The first embodiment of the present invention has mentioned the case where the X electrodes and the Y electrodes are arranged at equal pitches and parallel to each other. However, the present invention is not limited to the embodiment. For instance, in order to enhance the accuracy of detection of a position in a specific area, the electrodes may also be arranged at smaller pitches in only the perimeter of the detection panel as compared with the pitch in the other area.

In the first embodiment of the present invention, electrodes exhibiting the maximum detection values are sought, and these electrodes are taken as reference electrodes for the case of determination of a range. However, the present invention is not limited to the embodiment.

Although a previously-determined range is specified by means of a unit based on the arrangement pitch for electrodes, the present invention is not limited to this manner of specification. The range may also be specified as; for instance, a range of coordinates.

From the viewpoint of assuring ease of follow even when the number of detection positions per unit time is large, it is desirable to set the allowable time Td to a value of 30 msec or less and, more preferably, to a value of 10 msec or less.

Although the present invention is useful particularly for the case where the invention is applied to a large-size touch panel, the touch panel is not limited to a large size. Needless to say, the present invention is also applicable to a small-size touch panel.

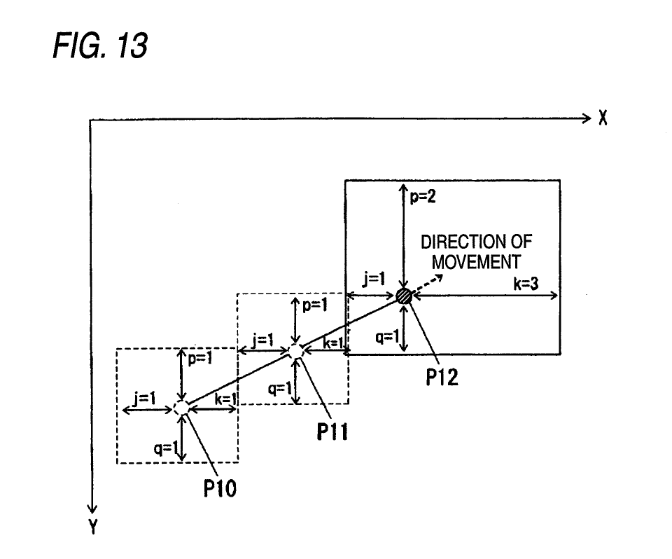

FIG. 13 is a view showing a case where a predetermined range is changed according to the direction and speed of movements of a detected position of a touch input on the capacitive touch panel of the first embodiment of the present invention. More specifically, FIG. 13 shows a case where the range is changed according to the direction and speed of movements of a detected position of a touch input.

When the position of a touch input moves in sequence of P10, P11, and P12, the coordinate calculation control section 10 calculates coordinates of the touch input position P10 and coordinates of the touch input position P11 detected every predetermined time Tp and subsequently determines the direction of movement and the speed of movement in each of the X and Y directions from the coordinates and the time Tp.

Depending on the thus-determined speeds and directions of movement, the coordinate calculation control section 10 sets values to be set in the electrode range setting section 21 to different values with respect to the respective X and Y coordinates.

FIG. 13 shows a case where coordinates (j, k)=(1, 1) and (p, q)=(1, 1) are achieved respectively at P10 and P11. In the foregoing, data corresponding to coordinates (j, k)=(1, 1) and (p, q)=(1, 1) are previously stored, as data used for determining a range with reference to an electrode exhibiting the maximum detection value, in the storage section (not shown) provided in the coordinate calculation section 10.

The coordinate calculation control section 10 predicts the speed of movement and the direction of movement from the coordinates of P10 and the coordinates of P11. A reference X electrode in relation to the direction of the X axis is determined from the plurality of detection values used for calculating coordinates of the position of the touch input and on the basis of the speed of movement in the direction of the axis X with respect to the direction of movement.

A range is determined with reference to the thus-determined X electrode, and the range is stored in the storage section (not shown) provided in the coordinate calculation section 10.

The coordinate calculation control section 10 determines an electrode situated within the stored range from the value counted from the X electrode 3a as previously mentioned and transmits a resultant count value to the detection period control section 17 by way of the communications I/F 24.

The detection period control section 17 received the count value sets the count value in the electrode range setting section 21 as identification information about the electrode situated in the range.

In relation to the direction of the Y axis, a range is also determined with reference to a Y electrode that is determined from the plurality detection values and on the basis of the speed of movement in the direction of the Y axis with respect to the direction of movement. The range is stored in the storage section (not shown) provided in the coordinate calculation section 10. Subsequently, the count value is set, as identification information about the electrode situated in the range, in electrode range setting section (not shown) provided in the Y coordinate detection period control section 9a in the same manner as mentioned previously.

Consequently, it is possible to prepare for a touch input at P12 over an area that is wider than the areas achieved at P10 and P11 while the sensitivity to the electrodes in the range is enhanced by predicting the direction of movement.

FIG. 13 shows a case where the position where the touch input is detected moves to the upper right and where coordinates (j, k)=(1, 3) and (p, q)=(2, 1) are acquired at P12.

As mentioned above, the range is changed according to the direction and speed of movement of the position where the touch input is detected, whereby detection is performed while the sensitivity to electrodes in the range is enhanced. As a result, when operation for inputting a drawing, such as lines or graphics, is performed, the chance of erroneous detection can be diminished. Therefore, occurrence of a failure like a break in a line or a graphic, can be prevented.

In this case, the number of times a touch input can be detected within a unit time can be maintained at a given number or a greater number as mentioned previously. Therefore, even when lines or graphics are drawn and input with a finger or a pen, the locus of coordinates of an input position are smooth, and user's sense of operation is not deteriorated.

Further, even when texts are input, the chance of occurrence of erroneous detection can be lessened. Hence, the present invention is also useful when applied to recognition of a gesture or handwriting.

Even when the arrangement pitch for the electrodes in the direction of the X axis differs from the arrangement pitch for the electrodes in the direction of the Y axis, it is possible to optimally set a range where sensitivity is enhanced in conformance to coordinates of a position where a touch input is detected, by setting a range of electrodes for each of the direction of the X axis and the direction of the Y axis, independently.

For instance, when the capacitive touch panel is used for an electronic white board, or the like, the breadth (the direction of the X axis) of the panel is larger than the length (the direction of the Y axis) of the panel in most cases. Even when the electrodes in the direction of the X axis and the electrodes in the direction of the Y axis are arranged at different pitches, the range where sensitivity is enhanced can be optimized.

In a case where there is performed operation for inputting handwriting, such as lines and drawings, even when the influence of guidance by a closed fist and extraneous noise varies from the electrodes laid in the direction of the X axis from the electrodes laid in the direction of the Y axis, the range where sensitivity is enhanced is optimized, thereby yielding an effect of the ability to perform stable detection.

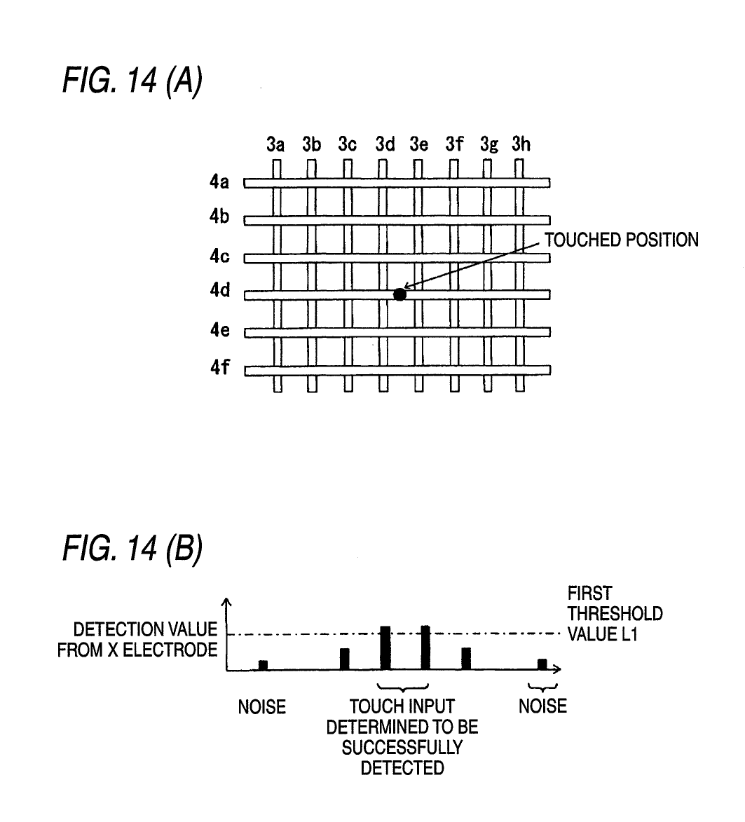

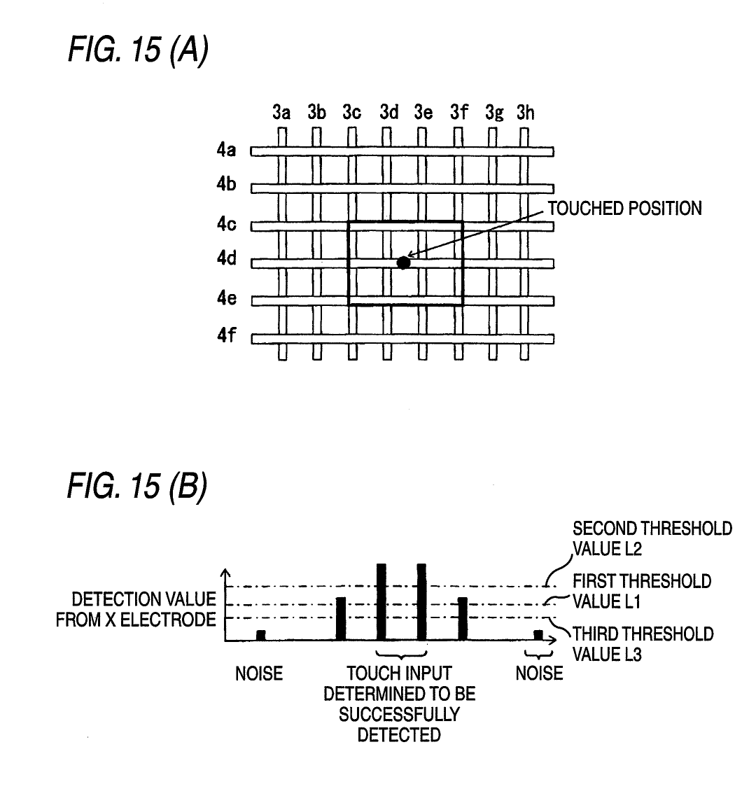

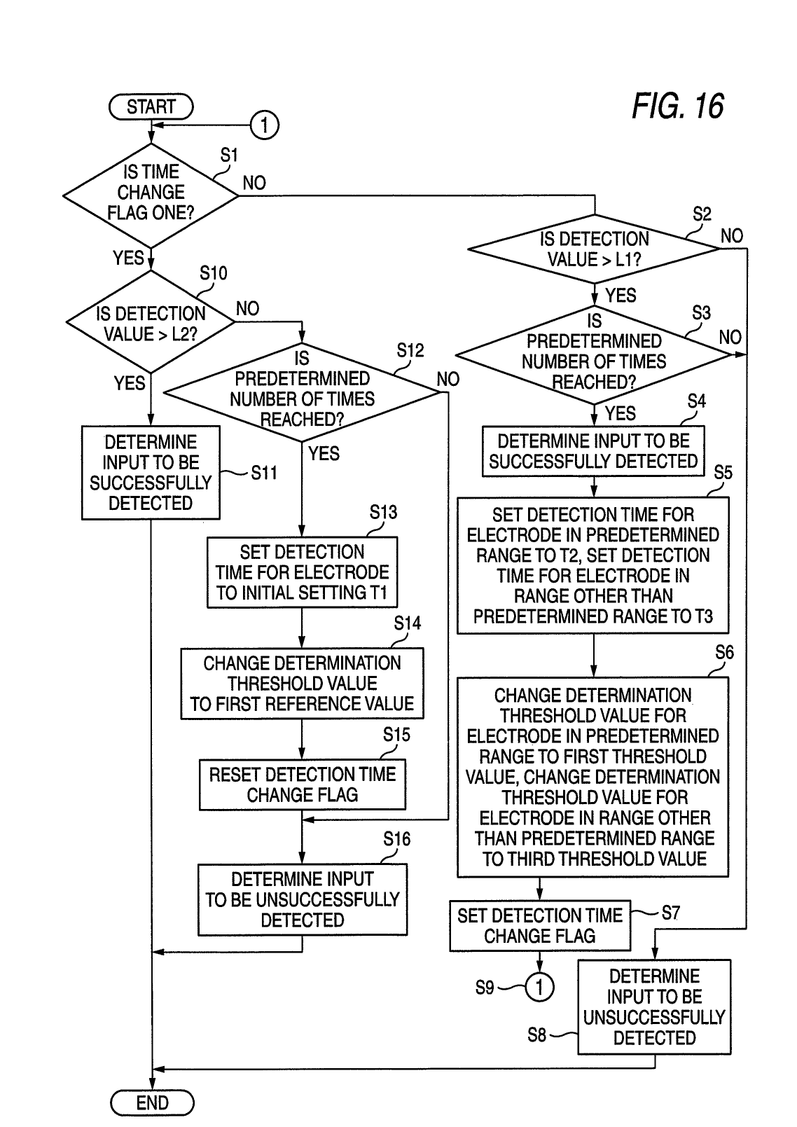

FIGS. 14A and 14B are views showing a first touch input to the capacitive touch panel of the first embodiment of the present invention and a detection value responsive to the entry. FIGS. 15A and 15B are views showing a detection value responsive to an input to electrodes in a predetermined range achieved after detection of a touch input to the capacitive touch panel of the first embodiment of the present invention. FIG. 16 is a flowchart for describing processing of a coordinate calculation control section making up the capacitive touch panel of the first embodiment of the present invention.

The first embodiment adopts a configuration (not shown) in which input determination section is provided in the coordinate calculation control section 10. The input determination section compares detection data transmitted from the respective detection control sections 8a and 9a to the coordinate calculation control section 10 with a plurality of threshold values previously stored in the coordinate calculation control section 10. When the plurality of sets of detection data surpass the first threshold value, the input determination section determines that a touch input is successfully detected.

FIGS. 14A and 15A are block diagrams of the electrodes. FIGS. 14B and 15B show detection values corresponding to the respective X electrodes achieved when a position indicated by an arrow is touched respectively in FIGS. 14A and 15A. For the sake of brevity, drawings showing detection values from respective Y electrodes are omitted.

First, when the position indicated by the arrow in FIG. 14A is touched, detection values acquired from the X electrodes resultant from the touch are assumed to be output as shown in FIG. 14B. A threshold value used for determining from the detection values acquired from the X electrodes that a touch input is detected is set to the first threshold value L1 at this time. It is determined whether a touch input is successfully detected or unsuccessfully detected, on the basis of a result of a determination as to whether or not the respective detection values acquired from the X electrodes 3d and 3e surpass the first threshold value L1.

As indicated by the arrow shown in FIG. 14A, when the position of the touch input is located at the midpoint between the X electrode 3d and the X electrode 3e with respect to the X coordinate, the detection values become smaller as compared with the case where a point immediately above the electrode is touched. For this reason, the first threshold value L1 is set to a small value such that a touch input can be detected even when a position between electrodes is touched. Detection values, however, become susceptible to noise, or the like, also.

Accordingly, once a touch input has been detected, detection sensitivity achieved at the X electrodes 3d and 3e in FIG. 15A is enhanced by increasing the detection period for these electrodes to T2, whereby detection values generated as a result of entry of a touch input are increased as shown in FIG. 15B.

The threshold value used for determining that a touch input is detected is additionally changed to the second threshold value L2 so as to satisfy a relationship L2>L1. When the detection values resultant from the touch input surpass L2, the coordinate calculation control section 10 working as the input determination section determines that the touch input is successfully detected.

After the touch input is determined to be successfully detected (an ON state), the threshold value used for determining that a touch input is unsuccessfully detected (an OFF state) is set to a third threshold value L3 that satisfies a relationship L3<L1<L2. When detection values resultant from a touch made subsequent to the determination of detection of the touch input (the ON state) is L3 or larger, the detected state of the touch input (the ON state) is maintained.

Once the touch input is determined to be successfully detected (the ON state), even when variations ascribable to noise or movement of the finger arise in the detected values, the detected state of the touch input (the ON state) is maintained. Stable operation for detecting a touch input and stable determination operation can be performed.

Once the input has been detected, a noise margin can be increased by (L2-L1); hence, detection values can be made less susceptible to the influence of guidance by a closed fist, extraneous noise, and the like.

Processing of the coordinate calculation control section 10 of the first embodiment is now described by reference to a flowchart shown in FIG. 16.

First, in the initial state, the coordinate calculation control section 10 determines whether or not a detection period change flag on a selected electrode is set (S1).

In the initial state, the detection period T1 is selected for the respective electrodes, and a detection period change flag is zero. Therefore, the coordinate calculation control section 10 determines that the detection period change flag is not set, and processing proceeds to step S2.

It is additionally determined in step S2 whether or not a detection value of the electrode surpasses the first threshold value L. When the detection value is determined to be L1 or more, it is also determined whether or not the number of determination operations has already reached a predetermined number of times (S3).

When the number of determination operations is determined to have reached the predetermined number of times in step S3, a touch input is determined to be successfully detected (S4). The detection period for electrodes located in the range previously determined with reference to the electrode is set to T2 (S5). Once the touch input has been determined to be successfully detected, a threshold value used for determining whether the touch input is successfully detected or the touch input is unsuccessfully detected is changed to the second threshold value L2 (S6).

The threshold value used for determining that a touch input is unsuccessfully detected (an OFF state) is changed to the third threshold value L3 at this time in step S6.

In relation to the electrodes located within the range previously determined with reference to the electrode, a detection period change flag showing that the detection period is changed from T1 to T2 is set to one (S7), and processing returns to step S1 (S9).

When the number of determination operations is determined not to have reached the predetermined number of times in step S3, the input is determined to be invalid (S8).

There is now described processing of the coordinate calculation control section 10 performed once the touch input has been determined to be successfully detected.

When the detection period change flag is determined to be set to one in step S1, it is determined whether or not the detection value acquired from the electrode is the second threshold value L2 or more (S10). When the detection value acquired from the electrode is determined to be L2 or more, the input is determined to be successfully detected (S11).

When the detection value acquired from the electrode is determined to be less than L2, it is determined whether or not the number of determination operations has already reached the predetermined number of times (S12).

When the number of determination operations is determined to have already reached the predetermined number of times in step S12, the detection period for the respective electrodes is reset to the default T1 (S13). Further, the threshold value used for determining whether the touch input is successfully detected or the touch input is unsuccessfully detected is reset to the first threshold value L1 (S14). Subsequently, the detection period change flag is reset to zero (S15), and the touch input is determined to be unsuccessfully detected (an OFF state) (S16).

When the number of determination operations is determined not to have yet reached the predetermined number of times in step S12, the touch input is determined to be unsuccessfully detected (the OFF state) (S16).

As mentioned previously, the detection sensitivity for the electrodes located in the predetermined range determined with reference to the coordinates of the touch input after detection of the touch input is enhanced, and the threshold value used for determining that the touch input is detected (the ON state) is set to a larger value. There is thereby yielded an advantage of the ability to make detection less susceptible to the influence of guidance by a closed fist, extraneous noise, and the like.

When the touch input is unsuccessfully detected for a given period of time or more, the detection period is reset to the detection period achieved before detection of the touch input, whereby it becomes possible to prepare for a new touch input with initial sensitivity.

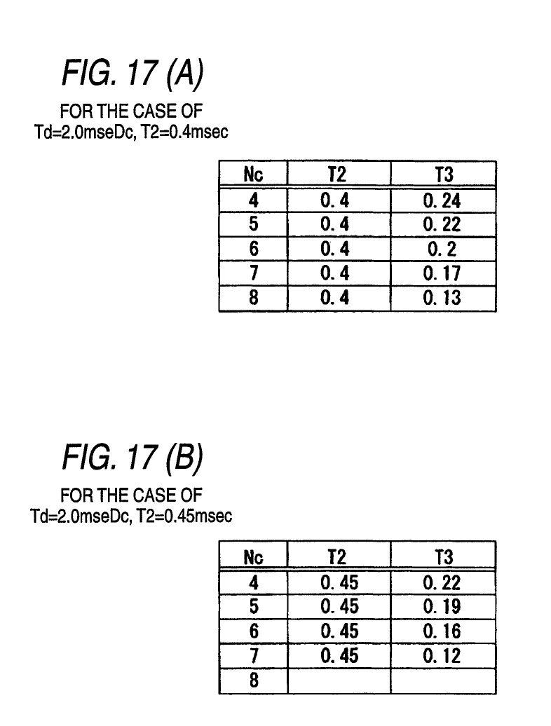

FIGS. 17A and 17B are views showing an example reference table employed in the capacitive touch panel of the first embodiment of the present invention; namely, example reference tables of T2 and T3.

In FIG. 8, the coordinate calculation control section 10 shown in FIG. 3 is described to calculate the detection period T2 or T3 by means of Expressions (3) and (4) in such a way that the total sum Ts of detection periods for the respective X and Y electrodes falls within the allowable time Td. As shown in FIGS. 17A and 17B, it may also be possible to set the values of T2 and T3 in a plurality of tables stored in memory, or the like, in advance, and determine values of T2 and T3 by reference to the table in accordance with the number of electrodes for which the detection period is changed.

In the embodiment shown in FIG. 3, a sum Nt of the number of X electrodes and the number of Y electrodes is 14. Provided that the allowable time Td is set to; for instance, 2.0 msec, values of T3 corresponding to a plurality of values of T2 are previously stored in memory (not shown) provided in the coordinate calculation control section 10 in the form of a table. Values of T2 and T3 can be determined by reference to the table.

FIG. 17A shows an example in which values of T3 are stored in the form of a table according to a value of Nc when the allowable time Td is set to 2.0 msec and when the value of T2 is set to 0.40 msec in advance. FIG. 17B shows an example in which values of T3 are stored in the form of a table according to a value of Nc when the allowable time Td is set to 2.0 msec and when the value of T2 is set to 0.45 msec in advance.

The essential requirement for the allowable time Td is to be set to an appropriate value in consideration of the number of electrodes, ease of following movement of the position of a touch input, and the like.

The second detection period T2 and the third detection period T3 are determined by reference to the table where their values are stored in advance, as mentioned above, whereby the amount of processing to be performed by the coordinate calculation control section 10 shown in FIG. 3 can be diminished. A delay before the predetermined range is set in response to a touch input can consequently be minimized.

Even when the capacitive touch panel of the present invention is applied to a large-size system as well as to a small-size system, it becomes possible to configure a capacitive touch panel exhibiting superior following of detection, noise resistance. Therefore, the present invention can be utilized for various position detection systems, such as a position detection apparatus for a projector and a large screen display unit.

This application is based upon and claims the benefit of priority of Japanese Patent Application No 2009-112450 filed on Sep. 5, 2007, the contents of which are incorporated herein by reference in its entirety.

What is claimed is:

1. A capacitive touch panel, comprising:
a detection surface;
a first electrode provided on the detection surface and including a plurality of electrodes arranged in parallel;
a second electrode provided on the detection surface and including a plurality of electrodes arranged in parallel along a direction crossing the first electrode;
a touch input detection section detecting a touch input on the detection surface made by a predetermined coordinate pointer in accordance with a change in an electrostatic capacitance between the first and second electrodes;
a detection period setting section that sets a period for selecting the first or second electrode so as to set a substantial detection period; and
a control section that controls the detection period set by the detection period setting section in accordance with a result of detection performed by the touch input detection section;
wherein the control section sets the detection period for an electrode from which the touch input is detected, among the first and second electrodes, longer than the detection period set theretofore.

2. The capacitive touch panel according to claim 1, wherein the control section selects a reference electrode from the first and second electrodes according to the result of detection; selects an electrode, from the first and second electrodes, situated in a predetermined range from the reference electrode; and also sets the detection period to a detection period longer than the detection period set theretofore with regard to the reference electrode and the selected electrode.

3. The capacitive touch panel according to claim 1, further comprising:
an input determination section that determines that the touch input is successfully detected or unsuccessfully detected, by comparing the result of detection performed by the touch input detection section with a preset first threshold value, wherein, when the input determination section determines that the touch input is successfully detected, the control section changes the first threshold value to a larger second threshold value and performs subsequent operation for detecting a touch input by means of the second threshold value.

4. The capacitive touch panel according to claim 1, wherein the control section sets the detection period to T1 in a state where the touch input is determined to be unsuccessfully detected and sets the detection period for the electrode, where the touch input is determined to be successfully detected, to T2 that is longer than T1 when the touch input is determined to be successfully detected.

5. The capacitive touch panel according to claim 1, wherein the input determination section has a third threshold value that is smaller than the second threshold value; compares a detection value acquired after the touch input is determined to be successfully detected with the third threshold value; and determines the touch input to be unsuccessfully detected when the detection value is less than the third threshold value.

6. The capacitive touch panel according to claim 1, wherein the control section selects, from the first and second electrodes, one located within a range except a predetermined range from the reference electrode, in accordance with the result of detection; and further sets the detection period for the selected electrode to T3 that is shorter the detection period set theretofore.

7. The capacitive touch panel according to claim 1, wherein the control section again sets the detection period to T1 when a touch input is determined to be unsuccessfully detected at any of the electrodes for a preset period of time or more after the input determination section has determined that the touch input is successfully detected.

8. The capacitive touch panel according to claim 1, wherein the control section changes the predetermined range according to a direction and a speed of movement of a position where the touch input is detected and performs subsequent operation for detecting a touch input by means of the changed range.

9. The capacitive touch panel according to claim 1, wherein the second electrode is arranged at equal pitches in a direction orthogonal to the first electrode, and the control section sets the predetermined range for each of the first electrode and the second electrode independently.

10. The capacitive touch panel according to claim 1, wherein the control section sets the detection periods T1, T2, and T3 for each of the first electrode and the second electrode independently.

11. A capacitive touch panel comprising: a coordinate input detection panel including first electrodes arranged parallel to each other and second electrodes arranged parallel to a direction orthogonal to the first electrodes; detection section that detects a change in electrostatic capacitance of the electrodes resulting from a coordinate pointer touching the first electrodes or the second electrodes in accordance with a change in frequency of an oscillation circuit; input determination section for determining, from a plurality of detection values output from the detection section, whether a touch input is successfully or unsuccessfully detected; detection period setting section that sets a detection period for the first or second electrodes; control section for changing detection sensitivity for the first or second electrodes by changing settings of the detection period setting section; a specifying section specifying a reference electrode, from the plurality of detection values from electrodes where a touch input is detected, for a case of determination of a preset range; and electrode range setting section that sets electrodes in the range with reference to the specified electrode, wherein the control section performs control operation such that detection operation is performed while enhancing detection sensitivity of the electrode set by the electrode range setting section, on the basis of an electrode where the touch input is detected among the first and second electrodes.

12. The capacitive touch panel according to claim 11, wherein the range is stored, with reference to the reference electrode, as a unit based on an arrangement pitch of the first or second electrodes.

13. The capacitive touch panel according to claim 11, wherein the electrode range setting section sets, on the basis of the range, electrode identification information independently on a direction of arrangement of the first electrodes and a direction of arrangement of the second electrodes.

14. The capacitive touch panel according to claim 11, wherein the control section changes the range according to a direction and a speed of movement of the position of the touch input determined from coordinates of a plurality of touch input positions and controls the detection section such that the touch detection operation is performed by setting the electrode identification information based on the changed range in the electrode range setting section.

15. The capacitive touch panel according to claim 11, wherein the input determination section further has, as a threshold value for determining that a touch input is unsuccessfully detected, a third threshold value that is smaller than the second threshold value; compares the third threshold value with a detection value acquired after the touch input is determined to be successfully detected; and determines that the touch is unsuccessfully detected when the detection value is less than the third threshold value.

16. The capacitive touch panel according to claim 11, wherein the second detection period setting section sets different detection period values for the first or second electrodes situated in the range, according to the preset range.

17. A touch input position detection method for a capacitive touch panel having a coordinate input detection panel including first electrodes arranged parallel to each other and second electrodes arranged parallel to each other along a direction orthogonal to the first electrodes, the method comprising:
performing operation for detecting a touch input when a touch input is unsuccessfully detected by setting a preset first detection period in the plurality of electrodes; and
performing touch input detection operation after detection of the touch input by setting a second detection period longer than the first detection period in an electrode, among the first and second electrodes, previously set on the basis of a positional relationship with coordinates of a position where the touch input is detected.

18. The touch input position detection method for a capacitive touch panel according to claim 17, wherein touch detection operation is performed by setting a third detection period shorter than the first detection period in electrodes except the electrode previously set on the basis of the positional relationship with the coordinates of the position where the touch input is detected.
